(19) United States
(12) Patent Application Publication
(10) Pub. No.: US 2022/0285664 A1
(43) Pub. Date: Sep. 8, 2022

(54) Method for Providing an Electrode Foil for Producing a Lithium-Ion Rechargeable Battery and Method for Producing a Lithium-Ion Rechargeable Battery

(71) Applicant: PlasmaTreat GmbH, Steinhagen (DE)

(72) Inventors: Alexander Knospe, Bad Muender (DE); Syed Salman Asad, Bielefeld (DE); Christian Buske, Bielefeld (DE); Hannes Goldmann, Paderborn (DE)

(21) Appl. No.: 17/631,911

(22) PCT Filed: Jul. 30, 2020
(86) PCT No.: PCT/EP2020/071479

§ 371 Date: Feb. 1, 2022

(30) Foreign Application Priority Data
Aug. 2, 2019 (DE) 10 2019 120 896.3

(51) Int. Cl. H01M 4/04; H01M 10/0525; H01M 4/131; H01M 4/1391; H01M 4/134; H01M 4/1395

(52) U.S. Cl. CPC H01M 4/0435; H01M 10/0525; H01M 4/0416; H01M 4/131; H01M 4/1391; H01M 4/134; H01M 4/1395

(57) ABSTRACT

The invention relates to a method for providing an electrode foil for producing a lithium-ion rechargeable battery, in which a metal foil is provided with a coating of electrode material and in which the coating of electrode material is plasma treated. The coating of electrode material is plasma-treated by the coating being subjected to an atmospheric plasma jet. The invention also relates to a method for producing a lithium-ion rechargeable battery, in which a first electrode foil for the negative electrode and a second electrode foil for the positive electrode are provided, in which the first and second electrode foils are arranged one above the other with a separator layer in between to form a foil stack and in which the foil stack is impregnated with a liquid electrolyte. The first and/or the second electrode foil is/are provided by the aforementioned method.

### CROSS-REFERENCE TO RELATED APPLICATIONS

This application is the United States national phase of International Application No. PCT/EP2020/071479 filed Jul. 30, 2020, and claims priority to German Patent Application No. 10 2019 120 896.3 filed Aug. 2, 2019, the disclosures of which are hereby incorporated by reference in their entirety.

### BACKGROUND OF THE INVENTION

### Field of the Invention

The invention relates to a method for providing an electrode foil for producing a lithium-ion rechargeable battery, in which a metal foil having a coating of electrode material is provided and in which the coating of electrode material is plasma-treated. The invention also relates to a method for producing a lithium-ion rechargeable battery, in which a first electrode foil for the negative electrode and a second electrode foil for the positive electrode are provided, in which the first and the second electrode foils are arranged one above the other with a separator layer in between to form a foil stack and in which the stack is impregnated with a liquid electrolyte.

### Description of Related Art

When producing lithium-ion rechargeable batteries, it is for example known to arrange one above the other an aluminium foil coated with lithium nickel manganese cobalt oxides for the positive electrode and a copper foil coated with graphite for the negative electrode with a separator layer in between in the form of a polypropylene mesh to form a foil stack; to roll up the foil stack to form a cylindrical roll or to fold it up to form a rectangular block; to arrange the roll or the block in a housing and to fill an electrolyte, for example lithium salts dissolved in ethylene carbonate, into the housing in order to impregnate the electrode material, i.e. the lithium nickel manganese cobalt oxide coating or graphite coating with the electrolyte.

To produce efficient and long-lasting rechargeable batteries, it is important that the electrode material is penetrated by the electrolyte used as completely as possible so that the lithium-ions in the rechargeable battery have a high freedom of movement. The impregnation of the electrode material with the electrolyte must therefore be carried out particularly carefully and can take some time during production. As a result, the production of lithium-ion rechargeable batteries is, however, relatively time-consuming and there is a need to reduce the production times of rechargeable batteries without restricting the efficiency of the rechargeable batteries.

To reduce the time required to impregnate the electrode material with electrolyte, attempts have been made to treat the electrode material in low-pressure chambers with inductively or capactively coupled plasma. These attempts were based on the idea of allowing a plasma to form in the pores of the typically porous electrode material coating in order to thereby increase the surface energy in such manner that a wetting with the electrolyte is improved.

This technique is, however, quite complicated due to the required low-pressure chambers and does not allow for any continuous operation that is favoured in terms of its process technology. Additionally, a reduction in the time for the complete impregnation of the electrode material with the electrolyte (impregnation time) has indeed actually been achieved with the low-pressure plasma treatment, but this time advantage has in part been used up again by the infeed and outfeed process into and out of the low-pressure chamber.

### SUMMARY OF THE INVENTION

Against this background, the object underlying the present invention is to provide a more efficient method for providing an electrode foil for producing a lithium-ion rechargeable battery as well as a more efficient method for producing a lithium-ion rechargeable battery.

In a method for providing an electrode foil for producing a lithium-ion rechargeable battery, in which a metal foil having a coating of electrode material is provided and in which the coating of electrode material is plasma-treated, this object is achieved according to the invention in that the coating of electrode material is plasma-treated by subjecting the coating to an atmospheric plasma jet.

In the case of the tests underlying this invention, it was found that a significant time-saving effect can be achieved in this way when impregnating the electrode material with electrolyte.

This is surprising since specialists have to date assumed that, for a significant time saving, the electrode material must be plasma-treated substantially over its entire volume, i.e. over the entire thickness of the coating, when being impregnated with electrolyte. Since the counterpressure of a gas contained under atmospheric pressure in the pores of the electrode material counteracts the ingress of a plasma and therefore would allow only quite a superficial plasma treatment, it has been assumed to date that only a vacuum plasma treatment would lead to the desired results.

However, as has now been found, a relatively superficial treatment of the electrode material by means of an atmospheric plasma jet is already sufficient to cause a significant effect in the absorption capacity of the electrode material for the electrolyte and therefore to achieve the desired time-saving effects when producing a lithium-ion rechargeable battery without complex and expensive vacuum environments.

The treatment of electrode material with an atmospheric plasma jet to reduce the time for the complete impregnation of the electrode material with the electrolyte therefore represents a complete departure from previous considerations.

In a method for producing a lithium-ion rechargeable battery, in which a first electrode foil for the negative electrode and a second electrode foil for the positive electrode are provided, in which the first and the second electrode foils are arranged one above the other with a separator layer in between to form a foil stack and in which the foil stack is impregnated with a liquid electrolyte, the above-mentioned object is further achieved according to the invention in that the first and/or the second electrode foil are provided using the above-described method.

In other words, in the method for producing a lithium-ion rechargeable battery, a first electrode foil for the negative electrode and a second electrode foil for the positive electrode are provided, the first and the second electrode foils are arranged one above the other with a separator layer in between to form a foil stack and the foil stack is impregnated with a liquid electrolyte, wherein the first and/or the second electrode foils are provided in that a respective metal foil having a respective coating of electrode material is provided and in that the coating of electrode material is plasma-treated by subjecting it to an atmospheric plasma jet.

The first electrode foil for the negative electrode has in particular a metal foil with a coating of electrode material for the negative electrode and the second electrode foil for the positive electrode has in particular a metal foil with a coating of electrode material for the positive electrode. A plastic mesh, for example a polypropylene mesh, can for example be used as the separator layer. A lithium salt, such as lithium hexafluorophosphate (LiPF₆), lithium tetrafluoroborate (LiBF₄) or lithium bis(oxalato)borate (LiBOB), dissolved in an anhydrous aprotic solvent, such as e.g. ethylene carbonate, is for example considered for the electrolyte.

In addition to the first and second electrode foil and the separator layer, the foil stack can comprise further layers, in particular an insulator layer to prevent undesired contacting of the electrode foils and therefore short circuits when rolling up or folding the foil stack.

Prior to impregnating the stack with the liquid electrolyte, the foil stack can in particular be rolled up or folded and preferably inserted into a battery housing.

Different embodiments of the previously described method for providing an electrode foil and of the previously described method for producing a lithium-ion rechargeable battery are described below, with the individual embodiments being applicable both for the method for providing an electrode foil for producing a lithium-ion rechargeable battery and for the method for producing a lithium-ion rechargeable battery and can also be combined with one another.

In a first embodiment, the metal foil having the coating of electrode material is provided by applying electrode material on the metal foil, in particular in the form of a water-based suspension, and by drying and rolling, in particular calandering, the electrode material applied on the metal foil, wherein the coating of electrode material is plasma-treated after rolling, in particular after calendering.

To obtain an electrode foil with a uniformly thin coating of electrode material, the electrode material applied on the metal foil can be calendered. In this case, the plasma treatment with the atmospheric plasma jet preferably only takes place after such calendering since calendering after the plasma treatment would lead to a weakening of the surface treatment achieved by the plasma treatment.

In an alternative embodiment, the plasma treatment can, however, also take place before calendering. Since the electrode material is still not compressed before the calendering, a plasma treatment penetrating deeper into the electrode material coating can be hereby achieved in some cases.

If the plasma treatment takes place after the rolling, in particular after the calendering, it is not necessarily a requirement that the plasma treatment takes place directly after the rolling or calendering, in fact further method steps can take place between the rolling or calendering and the plasma treatment, for example further drying, such as for example vacuum drying, of the coating of electrode material.

The electrode material can for example be applied on the metal foil in the form of a slurry. To this end, a mixture, in particular a suspension, of the actual electrode material and a liquid, is applied on the metal foil. The liquid is removed for example by drying so that a coating of electrode material remains on the metal foil.

In a further embodiment, the coating of electrode material is porous. In this way, the electrolyte can easily penetrate into the coating of electrode material and the effect of the plasma treatment by means of the atmospheric plasma jet can have its effect.

In an embodiment, an aluminium foil or a copper foil is used as the metal foil. An aluminium foil is in particular used for providing an electrode foil for the positive electrode, that is to say, for the cathode during the discharge process. A copper foil is in particular used for providing an electrode foil for the negative electrode, that is to say, for the anode during the discharge process.

In a further embodiment, the coating of electrode material contains one or a plurality of the following compounds or consists preferably at least up to 90% by weight thereof: lithium cobalt(III) oxide (LiCoO₂), lithium nickel manganese cobalt oxides (e.g. LiNiₓCo_{y}Mn_{z}O2), Li spinels (e.g. LiMn₂O₄), LiFePO₄. These compounds are suitable as electrode material for the positive electrode.

In a further embodiment, the coating of electrode material contains one or a plurality of the following compounds or consists preferably at least up to 90% by weight thereof: graphite, other Li-intercalated carbons, nanocrystalline, amorphous silicon, lithium titanates (e.g. Li₄Ti₅O₁₂), tin dioxide (SnO₂). These compounds are suitable as electrode material for the negative electrode.

The coating of electrode material can also have a binder, for example polyvinylidene fluoride or carboxymethyl cellulose and/or styrene butadiene rubber.

In a further embodiment, the atmospheric plasma jet is generated with a plasma nozzle, preferably by high-frequency electric, in particular arc-like, discharges between electrodes in a working gas flow. The plasma nozzle has in particular a working gas inlet and a nozzle opening from which the plasma jet exits.

By generating the plasma jet with high-frequency electric discharge between electrodes in a working gas flow, a reactive and simultaneously surface-friendly plasma jet is generated, with which the coating of electrode material can be effectively plasma-treated without damaging it. The reactivity of the plasma jet is high enough to achieve an adequate plasma treatment of the coating. By the plasma jet being directed at the coating, the reactive species in the plasma jet impact the coating at a relative speed, in spite of the superficial treatment at atmospheric pressure, quite a good penetration depth of the plasma jet into the coating is achieved such that the coating is plasma-treated at least starting from the surface up to a certain depth.

In a further embodiment, in order to generate the atmospheric plasma jet, a plasma nozzle with a nozzle arrangement is used which divides the plasma jet generated with the plasma nozzle into a plurality of partial jets exiting a plurality of openings of the nozzle arrangement. In particular, the multiple nozzle openings can be arranged along a channel of the nozzle arrangement. A suitable nozzle arrangement is for example known from DE 10 2016 125 699 A1. Using a plasma nozzle with such a nozzle arrangement allows a larger region of the coating of electrode material to be treated simultaneously such that the plasma treatment can be carried out more efficiently and in particular with a smaller number of plasma nozzles. In particular, a relative movement between the nozzle arrangement and the coating of electrode material allows a wider strip of the surface of the coating to be treated. It has been found that even when the plasma jet is divided into partial jets, an adequate treatment of the coating of electrode material can still be achieved.

### BRIEF DESCRIPTION OF THE DRAWINGS

Further features and advantages of the invention emerge from the following description of exemplary embodiments, with reference being made to the enclosed drawing, in which

FIG. 1a-e shows an exemplary embodiment of the method for providing an electrode foil for producing a lithium-ion rechargeable battery,

FIG. 2a-d shows an exemplary embodiment of the method for producing a lithium-ion rechargeable battery,

FIG. 3 shows a plasma nozzle that can be used for the method from FIG. 1,

FIG. 4 shows a further plasma nozzle with nozzle arrangement that can be used for the method from FIG. 1,

FIG. 5a-c shows a further exemplary embodiment of the method for providing an electrode foil for producing a lithium-ion rechargeable battery and

FIG. 6a-c shows a further exemplary embodiment of the method for producing a lithium-ion rechargeable battery.

### DESCRIPTION OF THE INVENTION

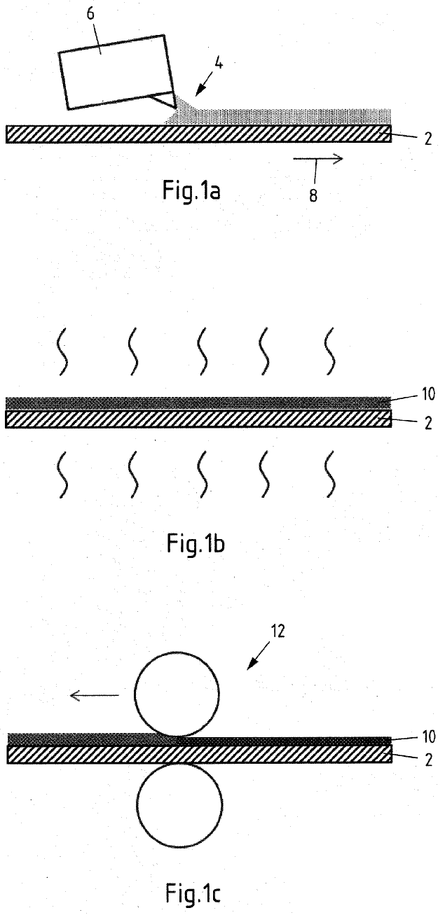

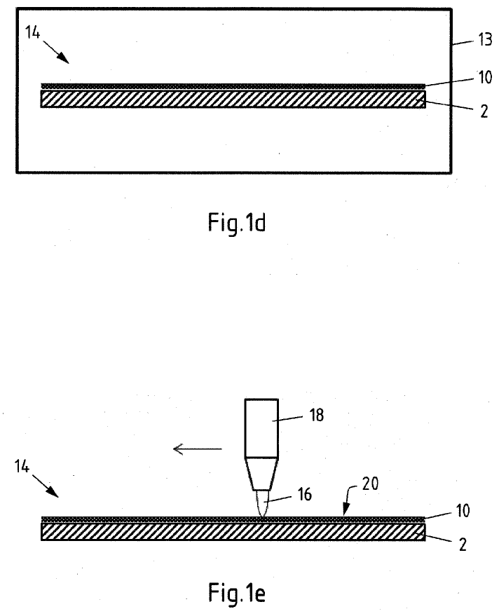

FIGS. 1a-e show an exemplary embodiment of the method for providing an electrode foil for producing a lithium-ion rechargeable battery in a schematic representation.

FIGS. 1a-d first show the provision of a metal foil with a coating of electrode material. To this end, a metal foil 2 is first provided in the first step represented in FIG. 1a and is coated with electrode material 4.

If an electrode foil is supposed to be produced for the positive electrode, the metal foil 2 can in particular be an aluminium foil and the electrode material can contain in particular one or a plurality of the following compounds or consist preferably at least up to 90% by weight thereof: lithium cobalt(III) oxide (LiCoO₂), lithium nickel manganese cobalt oxides (e.g. LiNiₓCo_{y}Mn_{z}O2), Li spinels (e.g. LiMn₂O₄), LiFePO₄.

If an electrode foil is supposed to be produced for the negative electrode, the metal foil 2 can in particular be a copper foil and the electrode material 4 can in particular contain one or a plurality of the following compounds or consist preferably at least up to 90% by weight thereof: graphite, other Li-intercalated carbons, nanocrystalline, amorphous silicon, lithium titanates (e.g. Li₄Ti₅O₁₂), tin dioxide (SnO₂).

The electrode material 4 can be applied on the metal foil as a slurry in the form of an aqueous suspension as illustrated in FIG. 1a. Such a slurry contains the actual electrode material and a liquid in which the electrode material is elutriated. The application of the electrode material 4 as a slurry is represented schematically in FIG. 1a by means of an application container 6 under which the metal foil 2 is moved away (arrow 8). However, any other suitable coating method can also be used.

In the second step represented in FIG. 1b, the electrode material 4 applied as the slurry is dried, for example in a drying furnace. In this way, the liquid of the slurry evaporates such that the electrode material 4 remains as a fixed coating 10 on the metal foil 2.

In the third step represented schematically in FIG. 1c, the coating 10 of electrode material 4 is rolled with a rolling device 12 such that the coating 10 obtains a uniform layer thickness and the material is compressed. The rolling device 12 can also be formed in particular in the form of a calender such that the metal foil 2 with coating 10 is calendered.

Then, in the fourth step represented in FIG. 1d, further drying, in particular vacuum drying in a vacuum furnace 13, takes place such that any liquid possibly remaining in the coating 10 evaporates.

The electrode foil 14 with the metal foil 2 and the coating 10 provided in this way are then plasma-treated in the step represented in FIG. 1e by the coating 10 being subjected to an atmospheric plasma jet 16, which is generated by means of high-frequency electric discharges between electrodes in a working gas flow in a plasma nozzle 18. In this way, the surface 20 of the coating 10 is plasma-treated up to a certain depth and therefore is prepared for subsequent impregnation of the coating 10 with liquid electrolyte.

The plasma treatment of the coating 10 can alternatively also take place before the second drying step represented in FIG. 1d.

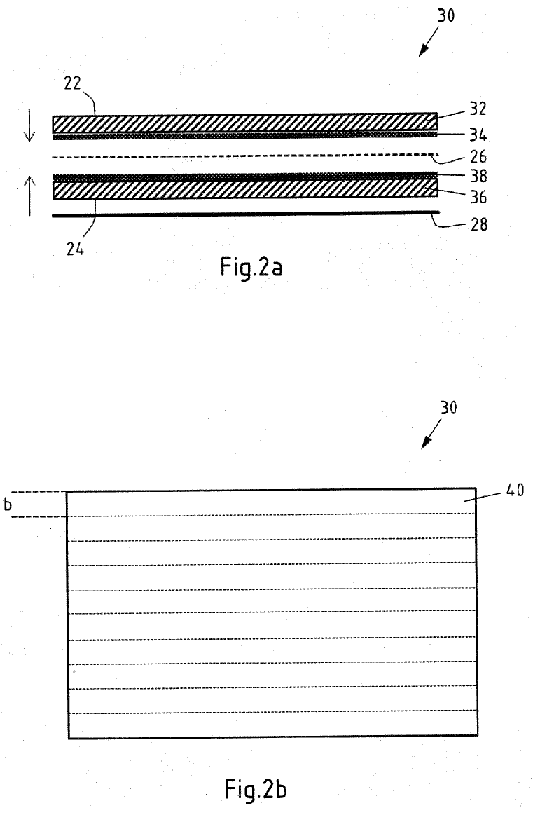

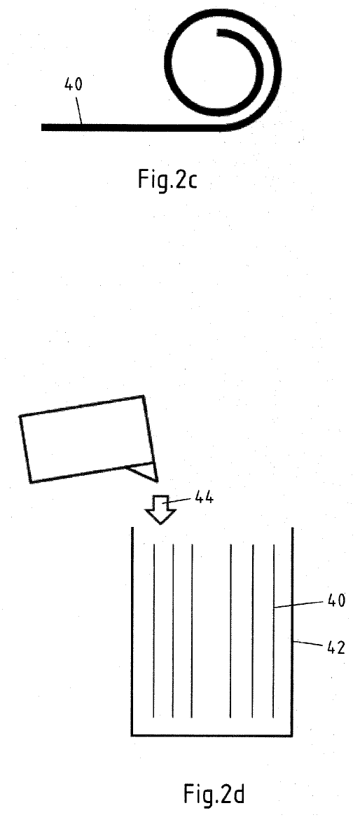

FIGS. 2a-d now show an exemplary embodiment of the method for producing a lithium-ion rechargeable battery in schematic representation.

In the first step represented in FIG. 2a, a first electrode foil 22 for the negative electrode, a second electrode foil 24 for the positive electrode, a separator layer 26, for example a mesh of polypropylene, as well as an insulator layer 28, for example a plastic foil, are provided and, as represented in FIG. 2a, are arranged one above the other to form a foil stack 30 in such manner that the separator layer 26 is arranged between the two electrode foils 22, 24. The insulator layer 28 can be arranged on the side of the second electrode foil 24, as represented in FIG. 2a, or, instead of this, on the side of the first electrode foil 22. The same material can be used for the insulator layer 28 as for the separator layer 26.

The first electrode foil 22 has a metal foil 32 and a coating 34 of electrode material for the negative electrode, for example a copper foil with graphite coating. The second electrode foil has a metal foil 36 and a coating 38 of electrode material for the positive electrode, for example an aluminium foil with lithium nickel manganese cobalt oxide coating. The separator layer 26 is used to prevent direct electrical contact of the two coatings 34, 38 of electrode material.

At least one, preferably both electrode foils 22, 24 represented in FIG. 2a, are provided using a method as illustrated in FIGS. 1a-e.

Accordingly, the coating of at least one, preferably the coatings of both electrode foils 22, 24, is plasma-treated with an atmospheric plasma jet.

FIG. 2b shows the foil stack 20 from FIG. 2a in plan view. Since the width of the individual foils of the foil stack 30 and therefore also the width of the foil stack 30 is wider than the width required to produce lithium-ion rechargeable batteries, the foil stack 30 is split into a plurality of strips 40, which have a width b suitable for producing the desired lithium-ion rechargeable batteries. Alternatively, the electrode foils 32, 36 as well as, if applicable, the separator layer 26 and, if applicable, the insulator layer 28 can also be split before stacking one on top of the other in FIG. 2a. Similarly, splitting the metal foil 2 before plasma-treating the coating 10 (FIG. 1e) or before the second drying (FIG. 1d) is conceivable.

In the step represented in FIG. 2c, such a strip 40 of the foil stack 30 is rolled up and then, as further illustrated in FIG. 2d in sectioned view, is inserted into a battery housing 42. Instead of rolling up to produce a cylindrical rechargeable battery, the strip 40 can also be folded in order to produce a rectangular rechargeable battery.

A liquid electrolyte 44 is filled into the housing 42 such that the electrolyte penetrates into the coatings 34, 38 of the two electrode foils 22, 24 of the strip 40 and therefore impregnates them. The previously performed treatment of the coating 34 and/or 38 with the atmospheric plasma jet 14 allows the time required to impregnate the coatings 34, 38 with the electrolytes to be reduced considerably.

In this way, the production time for lithium-ion rechargeable batteries can be reduced in an economic manner.

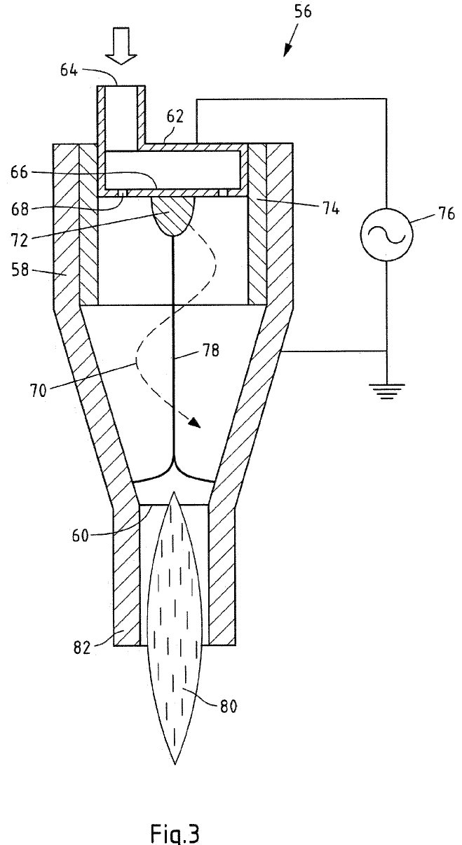

FIG. 3 shows in schematic sectioned view a plasma nozzle 56, which can be used for the method step represented in FIG. 1e. In particular, the plasma nozzle 16 can be formed like the plasma nozzle 56.

The plasma nozzle 56 has a nozzle tube 58 of metal which tapers substantially conically to a nozzle tube outlet 60. The nozzle tube 58 has a swirl device 62 with an inlet 64 for a working gas, for example air, at the end opposed to the nozzle tube outlet 60.

An intermediate wall 66 of the swirl device 62 has a crown of bores 68 arranged obliquely in the circumferential direction through which the working gas is swirled. The conically tapering, downstream part of the nozzle tube 58 is therefore flowed through by the working gas in the form of a vortex 70, whose core runs along the longitudinal axis of the nozzle tube 58.

An electrode 72 is arranged centrally on the underside 66 and protrudes into the nozzle tube 58 coaxially in the direction of the tapering section. The electrode 72 is electrically connected to the intermediate wall 66 and the other parts of the swirl device 62. The swirl device 62 is electrically insulated from the nozzle tube 58 by a ceramic tube 74. A high-frequency high voltage, which is generated by a transformer 76, is applied to the electrode 72 via the swirl device 62. The inlet 64 is connected via a hose, not shown, to a pressurised working gas source with a variable throughput. The nozzle tube 58 is earthed. The applied voltage generates a high-frequency discharge in the form of an arc 78 between the electrode 72 and the nozzle tube 58.

The terms “arc”, “arc discharge” or “arc-like discharge” are used in the present case as descriptions for the discharge since the discharge occurs in the form of an arc. The term “arc” is otherwise also used as the form of discharge in the case of direct current discharges with substantially constant voltage values. However, in the present case, it concerns a high-frequency discharge in the form of an arc, i.e. a high-frequency arc-like discharge.

Due to the swirl-like current of the working gas, this arc 78 is channeled in the vortex core on the axis of the nozzle tube 58 such that it first branches in the region of the nozzle tube outlet 60 towards the wall of the nozzle tube 58. The nozzle tube 58 therefore represents the counter electrode.

The working gas, which rotates in the region of the vortex core and therefore in direct proximity to the arc 78 at high flow speed, comes into close contact with the arc 78 and, as a result, is transferred in part to the plasma state such that an atmospheric plasma jet 80 exits the plasma nozzle 56 through the nozzle tube outlet 60 and through an outlet nozzle 82 adjoining the nozzle tube outlet 60.

The plasma jet 80 exiting the plasma nozzle 56 has a high reactivity and is surface-friendly due to its relatively low temperature at an already short distance from the outlet nozzle such that an effective treatment of the coating of electrode material can take place without it being damaged.

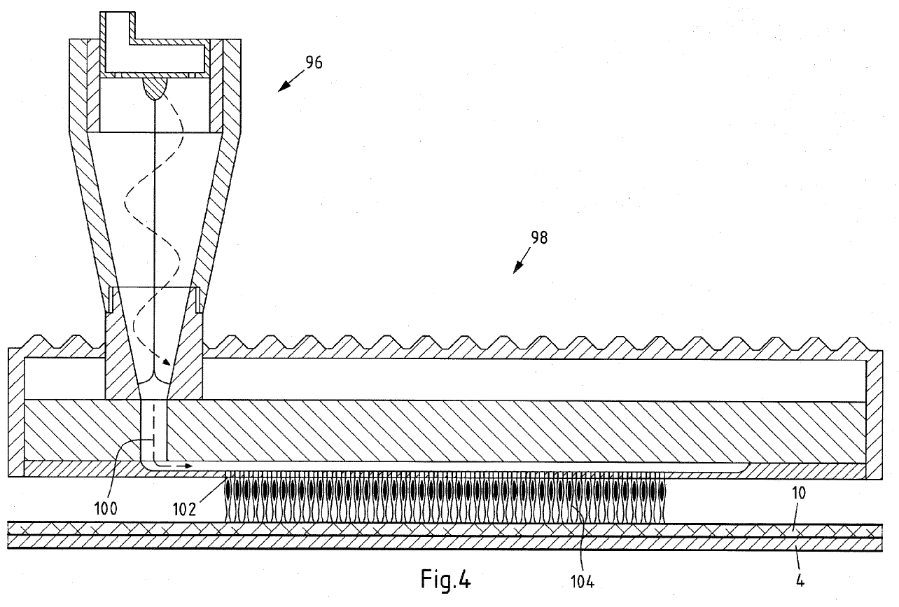

FIG. 4 shows in schematic sectioned view a further plasma nozzle 96 with a nozzle arrangement 98, which can be used in the method step represented in FIG. 1e. In particular, the plasma nozzle 16 can be formed like plasma nozzle 96 with connected nozzle arrangement 98.

The plasma nozzle 96 in principle has the same structure and the same mode of functioning as the plasma nozzle 56 from FIG. 3. The nozzle arrangement 98 is connected to the actual plasma nozzle 96 into which nozzle arrangement enters the plasma jet 80 from the plasma nozzle 96. This nozzle arrangement 98 has a channel 100 which is connected to the plasma nozzle 96 such that the plasma jet from the plasma nozzle 96 enters the channel 100.

A plurality of nozzle openings 102 are introduced next to one another into the channel wall of the channel 100 along the channel such that the plasma jet 80 is divided into a plurality of partial jets 104 which exit the individual nozzle openings 102. In this way, a curtain of plasma jets is achieved through which a larger region, in particular of the coating 10 from FIG. 1e, can be simultaneously plasma-treated. In this way, the plasma treatment of the coating 10 in FIG. 1e can be carried out efficiently and with a smaller number of plasma nozzles.

The plasma nozzle 96 with nozzle arrangement 98, which is represented in FIG. 4 and can be used for the method step shown in FIG. 1e, is essentially known from DE 10 2016 125 699 A1 to which reference is made for further possible features and functions of this plasma nozzle with nozzle arrangement.

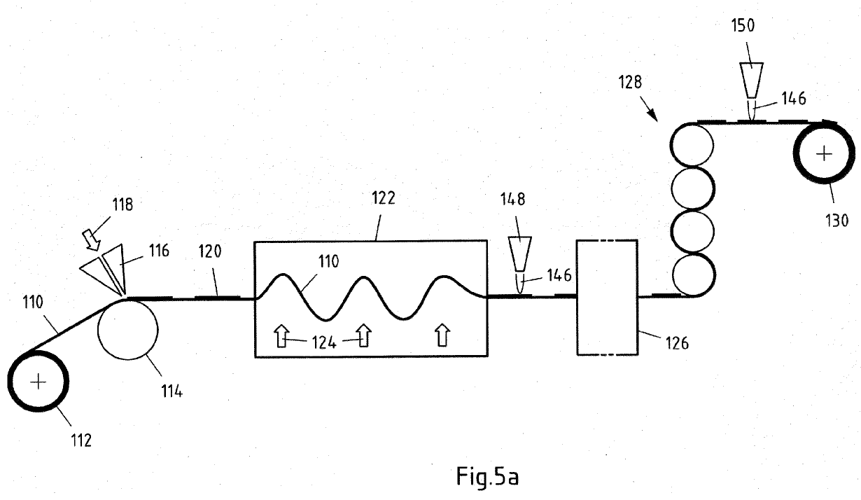

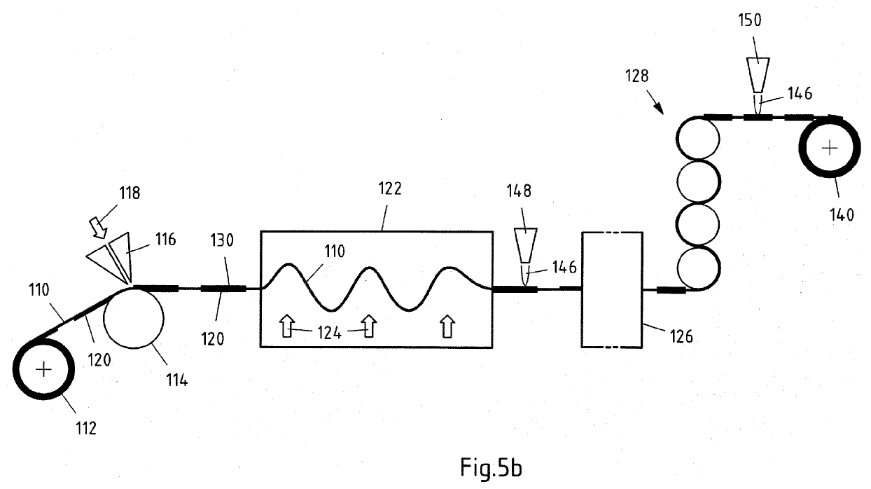

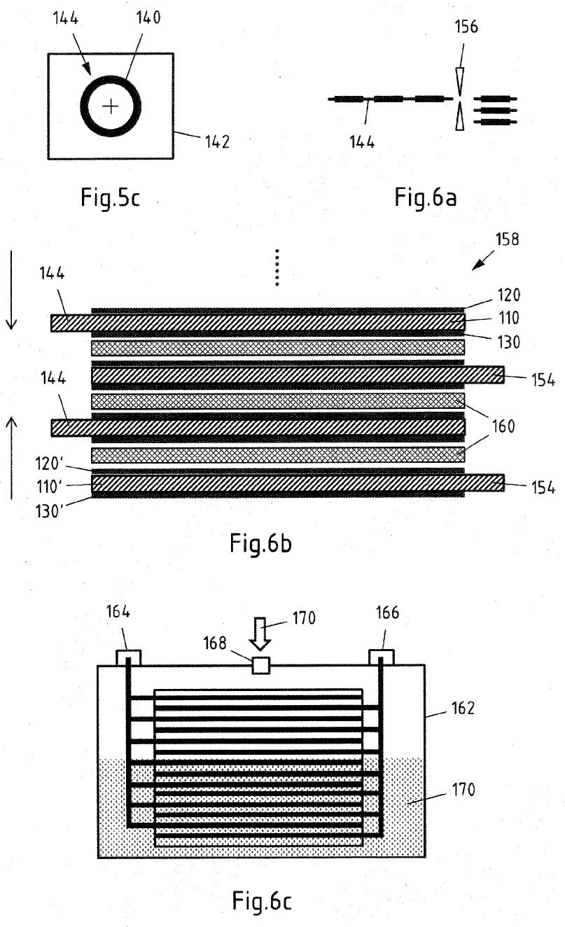

FIG. 5a-c show a further exemplary embodiment of the method for providing an electrode foil for producing a lithium-ion rechargeable battery in schematic view.

In the first step sequence represented in FIG. 5a, a metal foil 110 is unwound from a roll 112 and guided via a roll 114, opposite which is arranged a coating nozzle 116, with which the metal foil 110 is coated sectionwise with electrode material 118 in the form of an aqueous suspension such that one side of the metal foil 110 is provided sectionwise with coatings 120 of electrode material.

The metal foil 110 with the sectionwise coatings 120 is then dried in a floatation dryer 122, in which hot air 124 from below is blown against the metal foil 110. In this way, the majority of the water evaporates from the coatings 120.

After a subsequent cooling step in a cooling device 126, the metal foil 110 provided with the coatings 120 is calendered with a calender 128 and wound up into a roll.

In the second step sequence represented in FIG. 5b, the metal foil 110 provided on one side with sectionwise coatings 120 is also provided on the opposite side with corresponding sectionwise coatings 130 of electrode material 118, dried in the floatation dryer 122, cooled in the cooling device 126 and calendered with the calender 128 and rolled up into a roll 140.

In the step shown in FIG. 5c, the roll 140 is then vacuum-dried in a vacuum furnace 142 such that the finished electrode foil 144 is obtained.

To reduce the time for the complete impregnation of the coatings 120, 130 of electrode material with an electrolyte in the subsequent production of lithium-ion rechargeable batteries, the coatings 120 and 130 are subjected to an atmospheric plasma jet 146.

The application can for example take place after rough drying in the floatation dryer 122 with a plasma nozzle 148 arranged behind the floatation dryer. Alternatively, the application with the plasma jet 146 can also take place after calendering with a plasma nozzle 150 arranged behind the calender 128. Alternatively, the application with the plasma jet 146 can also take place after fine drying in the vacuum furnace 142. To this end, the roll 140 can for example be unwound and subjected to atmospheric plasma jets on both sides (not shown). The electrode foil 144 is completed in this case after the plasma treatment.

The one or plurality of plasma nozzles used to apply the plasma jet, in particular the plasma nozzle 148 or 150, can for example be formed like the plasma nozzle 56 or like the plasma nozzle 96 with nozzle arrangement 98.

FIG. 6a-c show a further exemplary embodiment of the method for producing a lithium-ion rechargeable battery.

An electrode foil for the positive electrode and an electrode foil for the negative electrode, each with sectionwise coatings of electrode material on both sides for the positive or negative electrode, are first provided using the method described in FIG. 5a-c. The electrode foil for the positive electrode can in particular be the electrode foil 144, with an aluminium foil having been used as the metal foil 110 and lithium nickel manganese cobalt oxide-containing electrode material 118 having been used for the coatings 120, 130. The electrode foil for the negative electrode can be an electrode foil 154 produced in a corresponding manner, with a copper foil having been used as the metal foil 110′ and graphite-containing electrode material 118 having been used for the coatings 120′, 130′.

The electrode foil 144 is cut into sections using a cutting device 156 in the step shown in FIG. 6a. In the same way, the electrode foil 154 is cut into sections in a step not shown.

The individual sections of the electrode foil 144 and 154 are then laid one on top of the other in an alternating manner, as shown in FIG. 6b, to form a stack 158, with each separator layer 160, for example in the form of a polypropylene mesh, being inserted to prevent the direct electrical contact of the coatings 120, 120′, 130,130′ of the successive electrode foils. The metal foils 110, 110′ of the electrode foils 144 and 154 each protrude to one side to enable subsequent contacting with the respective electrodes.

The finished stack 158 is inserted into a battery housing 162, as shown in FIG. 6c, with the protruding metal foils 110 of the electrode foils 144 being electrically connected to a positive battery pole 164 provided on the battery housing 162 and the protruding metal foils 110′ of the electrode foils 154 being electrically connected to a negative battery pole 166 provided on the battery housing 162.

Then, the battery housing 162 is filled with an electrolyte 170, for example with lithium salts dissolved in ethylene carbonate, through a provided fill opening 168 which then impregnates the coatings 120, 120′, 130, 130′ of the electrode foils 144, 154.

By the previous plasma treatment of the coatings 120, 120′, 130, 130′ with the atmospheric plasma jet it is achieved that the electrolyte 170 can better penetrate into the coatings 120, 120′, 130, 130′ such that the time for the impregnation of the coatings 120, 120′, 130, 130′ can be significantly reduced.

Tests have been carried out to examine the effect of the plasma treatment of the electrode material. To this end, samples of a copper foil coated with graphite and an aluminium foil coated with lithium nickel manganese cobalt oxides (NMC) were provided. The graphite coating of the copper foil contained carboxymethyl cellulose and styrene butadiene rubber as the binder. The lithium nickel manganese cobalt oxide coating of the aluminium foil contained polyvinylidene fluoride as the binder.

The graphite coating and the lithium nickel manganese cobalt oxide coating have each been plasma-treated by the coatings having been subjected to an atmospheric plasma jet, which has been generated with a plasma nozzle corresponding to the plasma nozzle represented in FIG. 3.

Drops of an electrolyte have then been applied on the plasma-treated coatings and the time until complete absorption of the drop into the coatings has been measured by means of contact angle measurement. A lithium hexafluorophosphate solution in ethylene carbonate-d₄ and ethyl methyl carbonate-cis (Sigma Aldrich, 746711) has been used as the electrolyte. The time for the absorption of the drop into the coating is an indicator of the time required for the complete impregnation of the electrode material with electrolyte.

Comparative tests have also been carried out with corresponding, but not plasma-treated, samples.

The results of the measurement are represented in the following Table 1:

TABLE 1

| | Without plasma | With plasma |
|---|---|---|
| Sample material | treatment | treatment |
| Copper foil with graphite | 23.4 s | 6.13 s |
| coating | | |
| Aluminium foil with NMC | 5.53 s | 3.45 s |
| coating | | |

As the test results in Table 1 show, the plasma treatment has in both cases reduced the time until complete absorption of the electrolyte drop, which accordingly indicates a reduced time until complete impregnation with electrolyte.

This shows that the electrolyte absorption by the electrode material can be significantly improved with the aid of the plasma treatment.

1. A method for providing an electrode foil for producing a lithium-ion rechargeable battery,
in which a metal foil having a coating of electrode material is provided and
in which the coating of electrode material is plasma-treated,
wherein the coating of electrode material is plasma-treated by subjecting the coating to an atmospheric plasma jet, wherein the atmospheric plasma jet is generated with a plasma nozzle.

2. The method according to claim 1,
wherein the metal foil having the coating of electrode material provided by applying electrode material on the metal foil and by drying and calendering the electrode material applied on the metal foil and
in that the coating of electrode material is plasma-treated after the calendering.

3. The method according to claim 1, wherein the coating of electrode material is porous.

4. The method according to claim 1,
wherein an aluminium foil or a copper foil is used as the metal foil.

5. The method according to claim 1,
wherein the coating of electrode material contains one or a plurality of the following compounds, preferably consists at least up to 90% by weight thereof: lithium cobalt(III) oxide, lithium nickel manganese cobalt oxides, Li spinel, LiFePO₄.

6. The method according to claim 1,
wherein the coating of electrode material contains one or a plurality of the following compounds, preferably consists at least up to 90% by weight thereof: graphite, other Li-intercalated carbons, nanocrystalline, amorphous silicon, lithium titanates, tin dioxide.

7. The method according to claim 1,
wherein the atmospheric plasma jet is generated by high-frequency electric discharges between electrodes a working gas flow.

8. The method according to claim 7, wherein, to generate the atmospheric plasma jet, a plasma nozzle with a nozzle arrangement used, which divides the plasma jet generated with the plasma nozzle into a plurality of partial jets exiting a plurality of nozzle openings the nozzle arrangement arranged along a channel.

9. The method for producing a lithium-ion rechargeable battery,
in which a first electrode foil the negative electrode and a second electrode foil for the positive electrode are provided,
in which the first and the second electrode foil are arranged one above the other with a separator layer in between to form a foil stack and
in which the foil stack is impregnated with a liquid electrolyte,
wherein the first and/or the second electrode foil are provided by a method according to claim 1.
